(19) United States
(12) Patent Application Publication
(10) Pub. No.: US 2010/0075145 A1
(43) Pub. Date: Mar. 25, 2010

(54) METAL-POLYMER HYBRID NANOMATERIALS, METHOD FOR PREPARING THE SAME METHOD FOR CONTROLLING OPTICAL PROPERTY OF THE SAME OPTOELECTRONIC DEVICE USING THE SAME

(76) Inventors: Jinsoo Joo, Seoul (KR); Dong-Hyuk Park, Seoul (KR)

Correspondence Address: CHRISTIE, PARKER & HALE, LLP, PO BOX 7068, PASADENA, CA, 91109-7068, US

(21) Appl. No.: 12/312,264

(22) PCT Filed: Sep. 16, 2008
(86) PCT No.: PCT/KR2008/005460

§ 371 Date: Apr. 30, 2009

(30) Foreign Application Priority Data
Sep. 13, 2007 (KR) 10-2007-0093340

(51) Int. Cl. C09K 11/02; C25D 5/56; C25D 21/12

(52) U.S. Cl. 428/376; 252/301.35; 205/87; 205/83

(57) ABSTRACT

Metal-polymer hybrid nanomaterials are provided. The hybrid nanomaterials comprise nanotubes or nanowires and metal layers formed on the inner or outer surfaces of the nanotubes or the outer surfaces of the nanowires. The nanotubes or nanowires include a light-emitting π-conjugated polymer and the metal layers are composed of a metal whose surface plasmon energy level is close to the energy band gap of the nanotubes or nanowires. Further provided are a method for preparing the hybrid nanomaterials, a method for controlling the optical properties of the hybrid nanomaterials, and an optoelectronic device using the hybrid nanomaterials. Energy transfer and electron transfer based on surface plasmon resonance increases the number of excitons in the conduction band of the nanotubes or nanowires including the light- emitting polymer, resulting in a remarkable increase in the luminescence intensity of the metal-polymer hybrid nanomaterials. The metal-polymer hybrid nanomaterials are easy to prepare and inexpensive while possessing inherent electrical and optical properties of carbon nanotubes. In addition, the electrical and optical properties of the metal-polymer hybrid nanomaterials can be easily controlled. Based on these advantages, the metal-polymer hybrid nanomaterials can be applied to a variety of optoelectronic devices, including light-emitting diodes, solar cells and photosensors.

### TECHNICAL FIELD

The present invention relates to metal-polymer hybrid nanomaterials, and more specifically to hybrid nanomaterials composed of an organic light-emitting polymer and a metal. The present invention also relates to a method for preparing the hybrid nanomaterials, a method for controlling the optical properties of the hybrid nanomaterials, and an optoelectronic device using the hybrid nanomaterials.

### BACKGROUND ART

Martin and his group have conducted the first research on organic nanomaterials. A major portion of research on organic nanomaterials has been devoted to the synthesis and characterization of organic nanomaterials using nanomaterials with excellent electrical properties. Additional concerns have focused on the fabrication of a variety of devices, including nanotransistors, nanobiosensors, chemical sensors and electrochromic devices, using organic nanomaterials with controllable electrical properties and the examination of the characteristics of the devices. The characteristics of poly(p-phenylenevinylene) (PPV), which is a representative light-emitting polymer, grown by chemical vapor deposition have been observed. Since then, a great deal of research has been conducted on light-emitting polymers.

Carbon nanotubes (CNTs) are a class of nanomaterials that are currently being investigated. Carbon nanotubes exhibit excellent mechanical, electrical and chemical properties compared to existing materials, and are suitable for use in electrical and electronic devices in terms of their size. Based on these advantages, extensive research on carbon nanotubes is underway in a variety of applications, including memory devices and field emission displays (FEDs). However, carbon nanotubes suffer from a disadvantage in that relatively high temperatures must be maintained during production. Other disadvantages are very complex and costly growth and purification processes. The physical and chemical properties of nanotubes are determined by the wall structure (e.g., single-wall or multi-wall) of the nanotubes. Further, there are difficulties in controlling the diameter and electrical properties of nanotubes. Another problem of nanotubes is poor processability.

In recent years, novel types of organic polymer/inorganic semiconductor/metal composite materials have been developed. Since such composite materials exhibit better characteristics than conventional organic materials, their potential applications have been reported in various fields. π-conjugated polymers can be exemplified as organic polymers for the composite materials. π-conjugated polymers can find application in electrical, electronic, optoelectronic devices and other devices because they undergo a phase transition from insulators to semiconductors or conductors through chemical doping while possessing inherent mechanical characteristics of polymers. Conductive polymers are used in practical and high-tech industrial applications, including secondary batteries, antistatic coatings, switching devices, nonlinear devices, capacitors, optical recording materials and electromagnetic shielding materials.

Much research on π-conjugated polymer nanomaterials has been directed to conductive polymers, but few studies have been done on light-emitting nanomaterials because of low luminescence intensity of the nanostructures, making it difficult to observe the luminescent properties of the nanostructures. Further, light-emitting nanomaterials tend to deform when exposed to ambient air, making the nanostructures difficult to apply to organic light-emitting devices.

### DISCLOSURE

### Technical Problem

A first object of the present invention is to provide metal-polymer hybrid nanomaterials with greatly enhanced luminescence intensity that are applicable to optoelectronic nanodevices.

A second object of the present invention is to provide a method for preparing the metal-polymer hybrid nanomaterials.

A third object of the present invention is to provide a method for controlling the optical properties of the metal-polymer hybrid nanomaterials.

A fourth object of the present invention is to provide an optoelectronic device using the metal-polymer hybrid nanomaterials.

### Technical Solution

In order to accomplish the first object of the present invention, metal-polymer hybrid nanomaterials are provided that comprise nanotubes or nanowires and metal layers formed on the inner or outer surfaces of the nanotubes or the outer surfaces of the nanowires wherein the nanotubes or nanowires include a light-emitting π-conjugated polymer and the metal layers are composed of a metal whose surface plasmon energy level is close to the energy band gap of the nanotubes or nanowires.

In an embodiment, energy may be transferred by surface plasmon resonance (SPR) between the surface plasmon energy level of the metal layers and the conduction band of the nanotubes or the nanowires.

In an embodiment, the light-emitting π-conjugated polymer may be doped with a dopant to form a bipolaron band within the band gap of the nanotubes or nanowires and electrons present in the bipolaron band are transferred to the Fermi level of the metal layers by surface plasmon resonance.

In an embodiment, the light-emitting π-conjugated polymer may be selected from the group consisting of polythiophene, poly(3-alkylthiophene), poly(3,4-ethylenedioxythiophene), polypyrrole, polyaniline, poly(1,4-phenylenevinylene), polyphenylene, derivatives thereof, and mixtures thereof.

In an embodiment, the metal layers may be composed of at least one material selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), and composites thereof.

In an embodiment, the dopant may be selected from the group consisting of camphorsulfonic acid, benzenesulfonic acid, p-dodecylbenzenesulfonic acid, tetrabutylammonium hexafluorophosphate, tetrabutylammonium tetrafluoroborate, naphthalenesulfonic acid, poly(4-styrenesulfonate), HCl, p-toluenesulfonic acid, and mixtures thereof.

In a preferred embodiment, the metal layers have a thickness of 1 to 50 nm.

In order to accomplish the second object of the present invention, there is provided a method for preparing metal-polymer hybrid nanomaterials, the method comprising (a) attaching an electrode metal to nanoporous templates, (b) mixing a polar solvent, a monomer and a dopant with stirring to prepare a solution, and polymerizing the solution within the nanopores of the nanoporous templates to form nanotubes or nanowires including a light-emitting π-conjugated polymer, (c) electrochemically depositing a metal whose surface plasmon band gap is close to the band gap of the nanotubes or nanowires on the inner or outer surfaces of the nanotubes or the outer surfaces of the nanowires to form metal layers, and (d) removing the porous templates.

In an embodiment, the polar solvent may be selected from the group consisting of H₂O, acetonitrile, N-methylpyrrolidinone, and mixtures thereof.

In an embodiment, the monomer may be selected from the group consisting of thiophene, 3-methylthiophene, 3-alkylthiophene, 3,4-ethylenedioxythiophene, pyrrole, aniline, 1,4-phenylenevinylene, phenylene, derivatives thereof, and mixtures thereof.

In an embodiment, the dopant may be selected from the group consisting of camphorsulfonic acid, benzenesulfonic acid, p-dodecylbenzenesulfonic acid, tetrabutylammonium hexafluorophosphate, tetrabutylammonium tetrafluoroborate, 1-butyl-3-methylimidazolium hexafluorophosphate, naphthalenesulfonic acid, poly(4-styrenesulfonate), HCl, p-toluenesulfonic acid, and mixtures thereof.

In an embodiment, the metal may be selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), composites thereof, and mixtures thereof.

In a preferred embodiment, the metal is deposited by applying a voltage of 0 to −1.0 V to the inner or outer surfaces of the nanotubes or nanowires using a cyclic voltammeter.

In an embodiment, the porous templates may be removed by dipping in an aqueous HF or NaOH solution.

In order to accomplish the third object of the present invention, there is provided a method for controlling the optical properties of metal-polymer hybrid nanomaterials, the method comprising (a) attaching an electrode metal to nanoporous templates, (b) mixing at least one polar solvent selected from the group consisting of H₂O, acetonitrile and N-methylpyrrolidinone, at least one monomer selected from the group consisting of thiophene, 3-methylthiophene, 3-alkylthiophene, 3,4-ethylenedioxythiophene, pyrrole, aniline, 1,4-phenylenevinylene, phenylene and derivatives thereof, and a dopant with stirring to prepare a solution, and polymerizing the solution within the nanopores of the nanoporous templates to form nanotubes or nanowires including a light-emitting π-conjugated polymer, (c) dipping the nanotubes or nanowires in an organic solution, and doping and dedoping the nanotubes or nanowires using a cyclic voltammeter, (d) electrochemically depositing a metal whose surface plasmon band gap is close to the band gap of the nanotubes or nanowires on the inner or outer surfaces of the nanotubes or the outer surfaces of the nanowires to form metal layers, and (e) removing the porous templates.

In an embodiment, the organic solution may be a solution of a dopant in acetonitrile.

In an embodiment, the dopants used in steps (b) and (c) may be each independently selected from the group consisting of camphorsulfonic acid, benzenesulfonic acid, p-dodecylbenzenesulfonic acid, tetrabutylammonium hexafluorophosphate, tetrabutylammonium tetrafluoroborate, 1-butyl-3-methylimidazolium hexafluorophosphate, naphthalenesulfonic acid, poly(4-styrenesulfonate), HCl, p-toluenesulfonic acid, and mixtures thereof.

In another embodiment, the metal may be selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), composites thereof, and mixtures thereof.

In a preferred embodiment, the metal is deposited by applying a voltage of 0 to −1.0 V to the inner or outer surfaces of the nanotubes or nanowires using a cyclic voltammeter.

In another embodiment, the porous templates may be removed by dipping in an aqueous HF or NaOH solution.

In a preferred embodiment, the luminescence intensity of the metal-polymer hybrid nanomaterials increases with increasing doping level. This phenomenon may be due to an electron transfer mechanism in which a bipolaron band is formed within the band gap of the nanotubes or nanowires by the dopant and electrons present in the bipolaron band migrate to the Fermi level of the metal layers by surface plasmon resonance.

In order to accomplish the fourth object of the present invention, there is provided an optoelectronic device comprising the metal-polymer hybrid nanomaterials.

### DESCRIPTION OF DRAWINGS

In the figures:

FIG. 1 shows schematic diagrams illustrating a method for the preparation of double walled nanotubes (DWNTs) according to an embodiment of the present invention;

FIGS. 2a, 2b and 2c are scanning electron microscopy (SEM) images of double walled nanotubes composed of polythiophene (PTh) nanotubes and nickel, copper and cobalt as inorganic metals, which were prepared in Examples 2, 1 and 3, respectively;

FIG. 3 shows a transmission electron microscopy (TEM) image and a diffraction pattern of one of double walled PTh/Ni nanotubes prepared in Example 2;

FIG. 4 is a high-resolution transmission electron microscopy (HR-TEM) image of a double walled PTh/Ni nanotube prepared in Example 2;

FIG. 5 shows a transmission electron microscopy (TEM) image and a HR-TEM image of one of double walled PTh/Cu nanotubes prepared in Example 1;

FIGS. 6a and 6b show the results of X-ray diffraction analysis for PTh/Ni nanotubes and PTh/Cu nanotubes prepared in Examples 2 and 1, respectively;

FIGS. 7a, 7b and 7c are SEM images of double walled nanotubes composed of poly(3-methylthiophene) (P3MT) nanotubes and nickel, copper and cobalt as inorganic metals, which were prepared in Examples 5, 4 and 6, respectively;

FIG. 8 shows a HR-TEM image and the results of energy dispersive spectra (EDS) of one of P3MT-Ni nanotubes prepared in Example 5;

FIG. 9 shows Fourier transform infrared (FT-IR) spectra of PTh, P3MT, PTh/Ni and P3MT/Cu nanotubes;

FIG. 10 shows UV/Vis absorption spectra of P3MT nanotubes and different kinds of P3MT-metal hybrid nanotubes in respective chloroform (CHCl₃) solutions;

FIG. 11 shows UV/Vis absorption spectra of PTh nanotubes and different kinds of PTh-metal hybrid nanotubes in respective chloroform (CHCl₃) solutions;

FIG. 12 shows photoluminescence (PL) spectra of different kinds of double walled nanotubes in chloroform (CHCl₃) solutions;

FIG. 13 shows two-dimensional emission images of single strands of different kinds of double walled PTh-metal nanotubes, which were measured by laser confocal microscopy;

FIG. 14 shows three-dimensional images comparing the amounts of light emitted from single strands of different kinds of double walled PTh-metal nanotubes, which were measured by laser confocal microscopy;

FIG. 15 shows PL spectra of single strands of different kinds of double walled PTh-metal nanotubes, which were measured by laser confocal microscopy;

FIG. 16 shows three-dimensional images comparing the amounts of light emitted from single strands of different kinds of double walled P3MT-metal nanotubes, which were measured by laser confocal microscopy;

FIG. 17 shows PL spectra of single strands of different kinds of double walled P3MT-metal nanotubes, which were measured by laser confocal microscopy;

FIG. 18 shows UV/Vis absorption spectra of nickel and copper nanowires measured to analyze the luminescent properties of double walled nanotubes;

FIG. 19 shows UV/Vis absorption spectra of P3MT nanotubes at different doping levels in chloroform (CHCl₃) solutions;

FIG. 20 shows two-dimensional emission images comparing the photoluminescence intensities of P3MT nanotubes and P3MT/Ni hybrid nanomaterials at different doping levels, which were measured by confocal microscopy;

FIG. 21 shows three-dimensional emission images of single strands of P3MT nanotubes at different doping levels, which were measured by laser confocal microscopy;

FIG. 22 shows photoluminescence spectra of single strands of P3MT nanotubes at different doping levels, which were measured by laser confocal microscopy;

FIG. 23 shows three-dimensional emission images of single strands of P3MT/Ni nanotubes at different doping levels, which were measured by laser confocal microscopy;

FIG. 24 shows photoluminescence spectra of single strands of P3MT/Ni nanotubes at different doping levels, which were measured by laser confocal microscopy;

FIG. 25 shows UV/Vis absorption spectra of P3MT/Ni hybrid nanotubes for the analysis of an enormous increase in photoluminescence at different doping levels;

FIG. 26 shows the PL quantum efficiency of P3MT nanotubes and P3MT/Ni hybrid nanotubes measured for the analysis of the luminescence efficiency depending on the bipolaron state; and

FIG. 27 is a conceptual energy band diagram for the analysis of an enormous increase in luminescence efficiency by energy transfer and charge transfer based on surface plasmon resonance.

### BEST MODE

Preferred embodiments of the present invention will now be described in detail with reference to the accompanying drawings.

In a first aspect, the present invention provides metal-polymer hybrid nanomaterials that comprise nanotubes or nanowires and metal layers formed on the inner or outer surfaces of the nanotubes or the outer surfaces of the nanowires wherein the nanotubes or nanowires include a light-emitting π-conjugated polymer and the metal layers are composed of a metal whose surface plasmon energy band gap is close to the band gap of the nanotubes or nanowires.

The luminescence intensity of the metal-polymer hybrid nanomaterials is a maximum of at least 350 times higher than that of conventional light-emitting polymer nanomaterials. Further, the color of the metal-polymer hybrid nanomaterials can be controlled by freely varying the maximum emission peak of the hybrid nanomaterials. Another advantage of the metal-polymer hybrid nanomaterials having a structure in which the metal layers surround the light-emitting polymer nanomaterials as cores is good stability to heat and other environmental factors.

According to the present invention, the light-emitting polymer nanomaterials and the metal may be used to form double walled nanostructures. As a result of analyzing a single strand of the light-emitting polymer and the hybrid nanomaterials of the present invention, it was found that the luminescent properties of the hybrid nanomaterials were greatly improved. The reason for the improvement in the luminescent properties of the hybrid nanomaterials is because the metal can induce surface plasmon resonance (SPR) consistent with the size of the band gap of the light-emitting polymer nanomaterials to form nanojunctions with the light-emitting polymer nanomaterials. Based on this organic luminescence, the hybrid nanomaterials of the present invention can be widely applied to optoelectronic devices.

The specific reason why the luminescence intensity of the metal-polymer hybrid nanomaterials according to the present invention increases is due to i) energy transfer by surface plasmon resonance between the surface plasmon energy level of the metal layers and the conduction band of the nanotubes or nanowires and ii) electron transfer in which the light-emitting π-conjugated polymer is doped with a dopant to form a bipolaron band within the band gap of the nanotubes or nanowires and electrons present in the bipolaron band migrate to the Fermi level of the metal layers, resulting in an increase in the number of excitons present in the conduction band of the light-emitting polymer nanomaterials.

Surface plasmon resonance (SPR) is an electromagnetic phenomenon in which evanescent waves excite electron density oscillation propagating along a metal/dielectric interface. Once surface plasmon resonance occurs, a strong electric field is created at the interfaces between the metal and the light-emitting polymer nanomaterials. The electric field is confined on the surfaces and decays exponentially in the directions perpendicular to the interfaces. The electric field intensity is about ten to one hundred times higher than when no surface plasmon are excited.

In the metal-polymer hybrid nanomaterials of the present invention, the metal layers may be present on the inner or outer surfaces of the nanotubes or surround the outer surfaces of the nanowires. It is preferred that the nanotubes or nanowires are present as cores and the metal layers surround the outer surfaces of the nanotubes or nanowires, because light incident on the hybrid nanomaterials passes the metal to reach the light-emitting polymer, which is advantageous in inducing surface plasmon resonance.

When nanoscale heterojunctions are formed between the light-emitting polymer nanomaterials and the metal layers, the Fermi level of the metal matches that of the light-emitting polymer (semiconductor) and the surface plasmon energy level of the metal lies above the conduction band of the nanomaterials. Next, depending on the doping state of the nanomaterials, electrons are transferred to the Fermi level of the metal through bipolarons formed within the band gap of the nanomaterials and energy is transferred to the nanomaterials through the surface plasmon energy level of the metal. As a result, more excitons are created in the conduction band of the nanomaterials, leading to an enormous increase in the luminescence efficiency of the light-emitting polymer. In conclusion, it is desirable that the surface plasmon energy level of the metal is similar to the band gap of the light-emitting polymer nanomaterials. More preferably, the surface plasmon energy level of the metal is slightly higher than the band gap of the light-emitting polymer nanomaterials.

Any light-emitting polymer having a π-conjugated structure may be used without any particular limitation in the present invention, and examples thereof include polythiophene, poly(3-alkylthiophene), poly(3,4-ethylenedioxythiophene), polypyrrole, polyaniline, poly(1,4-phenylenevinylene), polyphenylene and derivatives thereof. These light-emitting polymers may be used alone or as a mixture of two or more thereof.

As already mentioned, the metal layers may be composed of any metal whose surface plasmon energy level is close to the energy band gap of the nanotubes or nanowires including the light-emitting polymer. For example, the metal may be selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), composites thereof, and mixtures thereof.

The dopant is not especially limited so long as it is capable of forming a stable doping state. For example, the dopant may be selected from the group consisting of camphorsulfonic acid, benzenesulfonic acid, p-dodecylbenzenesulfonic acid, tetrabutylammonium hexafluorophosphate, tetrabutylammonium tetrafluoroborate, 1-butyl-3-methylimidazolium hexafluorophosphate, naphthalenesulfonic acid, poly(4-styrenesulfonate), HCl, p-toluenesulfonic acid, and mixtures thereof.

A preferable thickness of the metal layers is from 1 to 50 nm. If the metal layers are thinner than 1 nm, the metal particles do not aggregate, posing the risk that the metal layers may be not uniform. If the metal layers are thicker than 50 nm, a sufficient amount of light does not penetrate the metal layers, which is unfavorable in terms of surface plasmon generation.

In another aspect, the present invention provides a method for preparing metal-polymer hybrid nanomaterials. Specifically, the method of the present invention comprises (a) attaching an electrode metal to nanoporous templates, (b) introducing a solution of a polar solvent, a monomer and a dopant into nanopores of the nanoporous templates to form organic light-emitting nanotubes, (c) electrochemically depositing a metal whose surface plasmon band gap matches the band gap of the organic light-emitting nanotubes on the inner or outer surfaces of the nanotubes to form inorganic nanotubes, and (d) removing the porous templates. According to the method of the present invention, hybrid nanomaterials whose electrical and optical properties are easy to control can be prepared in a simple manner.

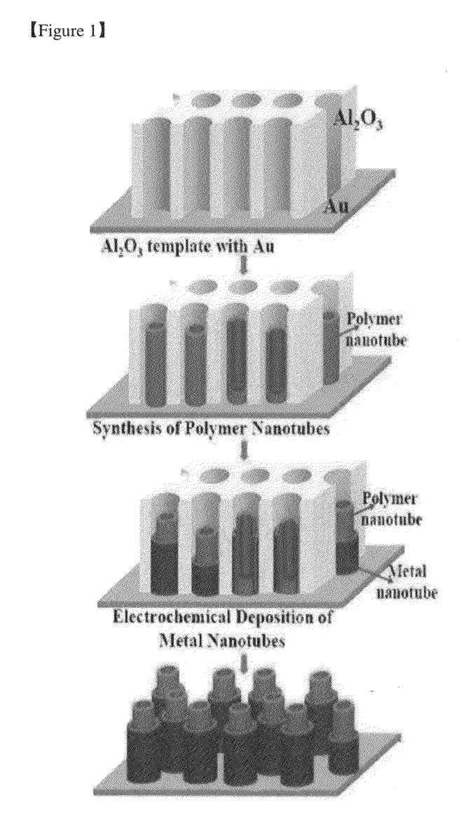

FIG. 1 schematically shows a method for preparing double walled nanotubes by electrochemical synthesis in accordance with an embodiment of the present invention. Referring to FIG. 1, first, a metal is deposited on nanoporous templates. The metal is used as an electrode in the subsequent step. The material for the nanoporous templates is not particularly limited so long as a light-emitting polymer can be electrically prepared within the nanopores. For example, the porous templates may be made of alumina (Al₂O₃). As the electrode metal, there can be used at least one metal selected from the group consisting of gold, silver, platinum, stainless steel, indium tin oxide (ITO), and composites thereof.

Subsequently, an organic solvent, a monomer and a dopant are mixed with stirring to prepare an electrochemical solution. The electrochemical solution is introduced into the porous alumina templates, and is then synthesized to form organic light-emitting polymer nanotubes or nanowires.

The state of the solution containing the polar solvent, the monomer and the dopant affects the formation of the nanotubes or nanowires. Several factors determining the state of the solution are temperature, pressure, and the kinds and molar ratio of the monomer and the dopant. That is, the nanotubes or nanowires can be synthesized in various shapes by varying the solution state and synthesis conditions during electrical polymerization. For example, a relatively short polymerization time at a given voltage provides the nanotubes, and a relatively long polymerization time at a given voltage provides the nanowires.

The polar solvent may be selected from the group consisting of H₂O, acetonitrile, N-methylpyrrolidinone, and mixtures thereof. The monomer may be selected from the group consisting of thiophene, 3-methylthiophene, 3-alkylthiophene, 3,4-ethylenedioxythiophene, pyrrole, aniline, 1,4-phenylenevinylene, phenylene, derivatives thereof, and mixtures thereof.

Two or three of the above-mentioned monomers may be used to prepare a copolymer or terpolymer. The shape and physical properties of the nanomaterials may be controlled by varying the applied current, time, the ratio between the monomer and the dopant, etc. Particularly, the diameter of the nanotubes or nanowires can be determined depending on the nanopore size of the porous templates. The diameter of the nanotubes or nanowires may be a factor determining the physical properties of the nanotubes or nanowires. For example, the conductivity of the nanotubes or nanowires can be optimized by varying the nanopore size of the porous templates. In addition, the doping with the dopant and subsequent dedoping can allow the nanotubes or nanowires to have optical properties of insulators, semiconductors or conductors, which makes the nanotubes or nanowires useful in a wide range of applications.

Some dopants suitable for use in the present invention are exemplified below:

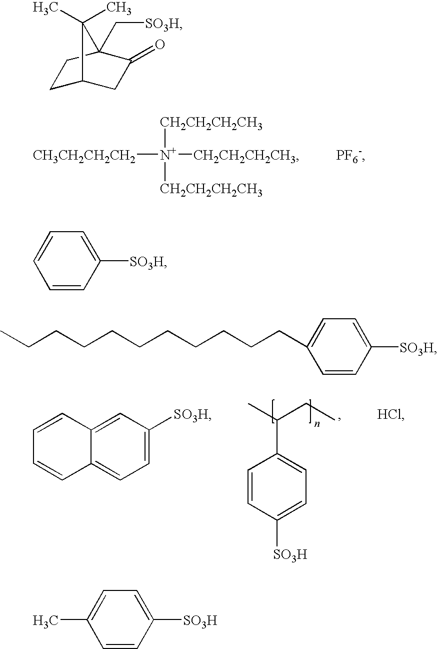

The light-emitting polymer nanomaterials may be selected from the group consisting of polyaniline, polypyrrole, poly(3,4-ethylenedioxythiophene) (PEDOT), polythiophene, poly(3-alkylthiophene), poly(1,4-phenylenevinylene), poly(2-methoxy-5-(2-ethylhexyloxy)-1,4-pheneylenevinylene) (MEH-PPV), poly(p-phenylene), derivatives thereof, and mixtures thereof.

Thereafter, metal layers are formed on the inner or outer surfaces of the nanotubes or the outer surfaces of the nanowires using a cyclic voltammeter. Specifically, a salt of a desired metal is dissolved in deionized water, the templates including the light-emitting polymer nanomaterials formed therein are dipped in the aqueous solution, and a voltage of 0 to −1.0 V is applied thereto to deposit metal layers on the light-emitting polymer nanomaterials.

As already mentioned, the metal layers may be composed of any metal whose surface plasmon energy level is close to the energy band gap of the light-emitting polymer nanomaterials. For example, the metal may be selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), composites thereof, and mixtures thereof.

The porous templates must be removed to obtain the double walled nanotubes or nanowires in pure forms. To this end, the porous templates are removed by dipping in an aqueous HF or NaOH solution to leave the dedoped double walled nanotubes or nanowires. Alternatively, the porous templates are removed by dipping in a solution of ethanol, water and HF in a suitable ratio to leave the doped double walled nanotubes or nanowires.

It is preferable that the thickness of the metal layers constituting the hybrid nanomaterials is from 1 to 50 nm. At a thickness of less than 1 nm, there is the risk that the metal layers may be not uniform because the metal particles do not aggregate. A thickness of more than 50 nm is undesirable in terms of surface plasmon generation and light transmission.

In another aspect, the present invention provides a method for controlling the optical properties of metal-polymer hybrid nanomaterials. Specifically, the method of the present invention comprises (a) attaching an electrode metal to nanoporous templates, (b) mixing at least one polar solvent selected from the group consisting of H₂O, acetonitrile and N-methylpyrrolidinone, at least one monomer selected from the group consisting of thiophene, 3-methylthiophene, 3-alkylthiophene, 3,4-ethylenedioxythiophene, pyrrole, aniline, 1,4-phenylenevinylene, phenylene and derivatives thereof, and a dopant with stirring to prepare a solution, and polymerizing the solution within the nanopores of the nanoporous templates to form nanotubes or nanowires including a light-emitting π-conjugated polymer, (c) dipping the nanotubes or nanowires in an organic solution, and doping and dedoping the nanotubes or nanowires using a cyclic voltammeter, (d) electrochemically depositing a metal whose surface plasmon band gap is close to the band gap of the nanotubes or nanowires on the inner or outer surfaces of the nanotubes or the outer surfaces of the nanowires to form metal layers, and (e) removing the porous templates.

Step (c) is the most crucial in controlling the optical properties of the metal-polymer hybrid nanomaterials. As the doping proceeds, new bands of polarons and bipolarons are formed in the band gap of the nanotubes or nanowires. The newly formed bands impede the conversion of the excitons to light energy to considerably reduce the luminescence efficiency of the light-emitting polymer. However, in the double walled hybrid nanostructures including the nanoscale inorganic metal, electrons present in the bipolaron band are transferred in a surface plasmon resonance state to form a larger number of excitons. That is, an increase in doping level leads to a dramatic increase in the luminescence efficiency of the hybrid nanostructures. In comparison with the simple light-emitting polymer nanomaterials, the hybrid nanomaterials of the present invention exhibits increased luminescence efficiency due to the presence of the metal layers but a red shift is observed because the energy band gap of the light-emitting polymer is somewhat reduced. This red shift can also be utilized to control the optical properties of the hybrid nanomaterials.

In yet another aspect, the present invention provides an optoelectronic device fabricated using the metal-polymer hybrid nanomaterials. As the optoelectronic device, there may be exemplified a light-emitting diode, a solar cell or a photosensor.

### [Mode for Invention]

Hereinafter, the present invention will be explained in more detail with reference to the following examples. However, these examples are not to be construed as limiting the scope of the invention.

### Examples

### Examples 1-9

Gold (Au) was deposited on porous anodic aluminum oxide (Al₂O₃) templates (d=25 or 47 mm, pore size≦0.2 μm, Whatman), and stainless steel was attached thereto Subsequently, acetonitrile (CH₃CN) as an organic solvent, thiophene, 3-methylthiophene or 3-buthylthiophene as a monomer and tetrabutylammonium hexafluorophosphate (TBAPF₆, Aldrich) as a dopant were mixed with stirring for 30 minutes to prepare a homogeneous electrochemical solution. Next, the alumina porous template electrode was put into the electrochemical solution, followed by electrochemical polymerization to prepare organic light-emitting polymer nanotubes. Then, copper (Cu), nickel (Ni), cobalt (Co) or gold (Au) was uniformly deposited to a thickness of about 10 nm using cyclic voltammeter (CV) to form metal layers surrounding the outer surfaces of the organic light-emitting polymer nanotubes. Solutions for the growth of the metal layers had the following compositions:

Copper: CuSO₄.H₂O (238 g/L), sulfuric acid (21 g/L)

Nickel: NiSO₄.H₂O(270 g/L), NiCl₂.6H₂O (40 g/L), H₃BO₃ (40 g/L)

Cobalt: CoSO₄.H₂O (266 g/L), H₃BO₃ (40 g/L)

Gold: H₃BO₃ in KAu(CN)₂ solution, pH 3.5

Deionized double-distilled water was used as a common solvent. The metal salts were dissolved before use. The metals copper (Cu), nickel (Ni), cobalt (Co) and gold (Au) were deposited at voltages of 0 V, −1.0 V, −1.0 V and −1.0 V, respectively. The alumina porous templates were removed from the stainless steel by dipping in a 2M aqueous HF solution to leave metal-polymer hybrid nanomaterials composed of the light-emitting polymer nanomaterials and the nanoscale metal layers coated thereon.

### Comparative Examples 1 to 3

Light-emitting polymer nanomaterials in pure forms were prepared in the same manner as in Example 1, except that no metal layers were formed by deposition.

Table 1 shows the organic light-emitting polymers and metals used in Examples 1-9 and Comparative Examples 1-3.

TABLE 1

| | Light-emitting polymer | Metal |
|---|---|---|
| Example 1 | PTh | Cu |
| Example 2 | PTh | Ni |
| Example 3 | PTh | Co |
| Example 4 | P3MT | Cu |
| Example 5 | P3MT | Ni |
| Example 6 | P3MT | Co |
| Example 7 | P3BT | Ni |
| Example 8 | P3BT | Cu |
| Example 9 | P3BT | Au |
| Comparative Example 1 | PTh | — |
| Comparative Example 2 | P3MT | — |
| Comparative Example 3 | P3BT | — |

### Examples 10 to 13

Preparation of Light-Emitting Polymer Nanomaterials and Control of Doping States

Gold (Au) was deposited on porous anodic aluminum oxide (Al₂O₃) templates (d=25 or 47 mm, pore size≦0.2 μm, Whatman), and stainless steel was attached thereto. Subsequently, thiophene, 3-methylthiophene or 3-buthylthiophene as a monomer and tetrabutylammonium hexafluorophosphate (TBAPF₆, Aldrich) as a dopant (5:1 (mol/mol)) were mixed in acetonitrile (CH₃CN) as an organic solvent with stirring for 30 minutes to prepare a homogeneous electrochemical solution. Next, the alumina porous template electrode was put into the electrochemical solution, followed by electrochemical polymerization to prepare organic light-emitting polymer nanotubes. Thereafter, the templates including the nanotubes formed therein were dipped in a 0.1 M solution of 1-butyl-3-methylimidazolium hexafluorophosphate (BMIMPF₆) in acetonitrile without any monomer. The doping level was controlled using a cyclic voltammeter. The doping was carried out at a voltage of 0 V to −1.0 V, and dedoping was carried out at a voltage of 0 V to 1.0 V. Ten cycles of oxidation and reduction were performed at the voltages to obtain samples having a doping level of 0.67 (Example 13) and 0.04 (Example 10). A sample having a doping level of 0.52 (Example 12) was subjected to reduction (5 cycles) to obtain a sample having a doping level of 0.25 (Example 11).

Deposition of Metal Layers

Nickel (Ni) was uniformly deposited to a thickness of about 10 nm using a cyclic voltammeter (CV) to nickel layers surrounding the outer surfaces of the organic light-emitting polymer nanotubes with different doping levels. A solution of NiSO₄.H₂O (270 g/L), NiCl₂.6H₂O (40 g/L) and H₃BO₃ (40 g/L) in deionized double-distilled water was used to grow the nickel layers. The alumina porous templates were removed from the stainless steel by dipping in a 2M aqueous HF solution to leave metal-polymer hybrid nanomaterials composed of the light-emitting polymer nanomaterials and the nanoscale metal layers coated thereon.

### Experimental Example 1

A scanning electron microscope (SEM), a transmission electron microscope (TEM) and a high resolution TEM (HR-TEM) were used to identify the growth of the double walled nanotubes, and UV/Vis absorption spectra were recorded to identify the structural and optical properties of the double walled nanotubes. FT-IR and photoluminescence (PL) analyses were performed. Single strands of the different kinds of nanostructures were characterized by PL analysis using a laser confocal microscope.

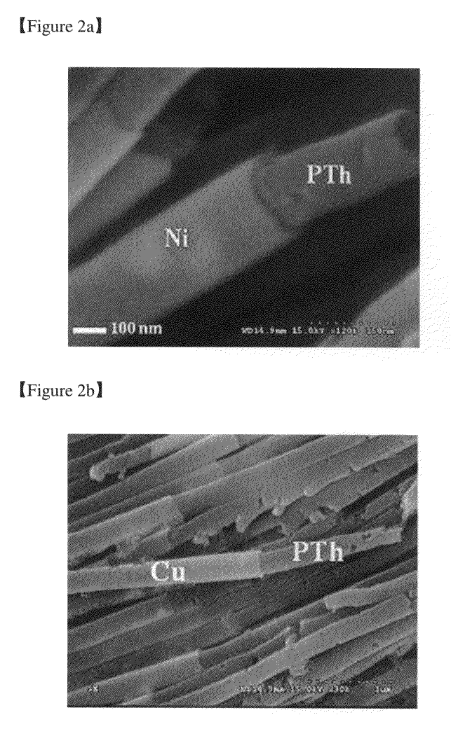

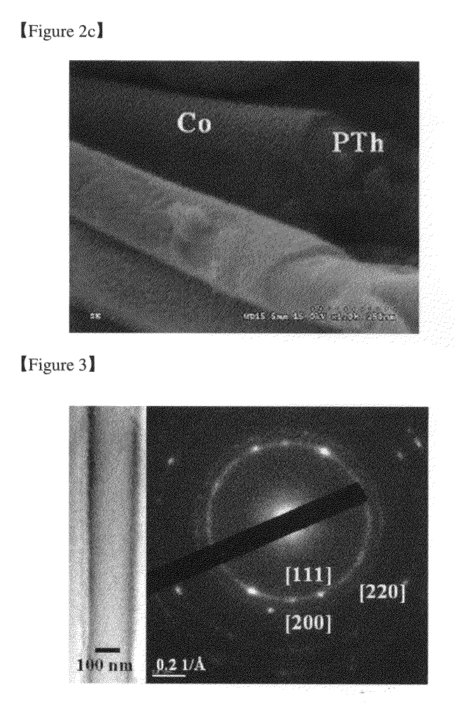

FIGS. 2a, 2b and 2c are scanning electron microscopy (SEM) images of the double walled nanotubes composed of polythiophene (PTh) nanotubes and nickel, copper and cobalt as inorganic metals, respectively. These images show that nickel, copper and cobalt layers were formed on the outer surfaces of the respective polythiophene nanotubes.

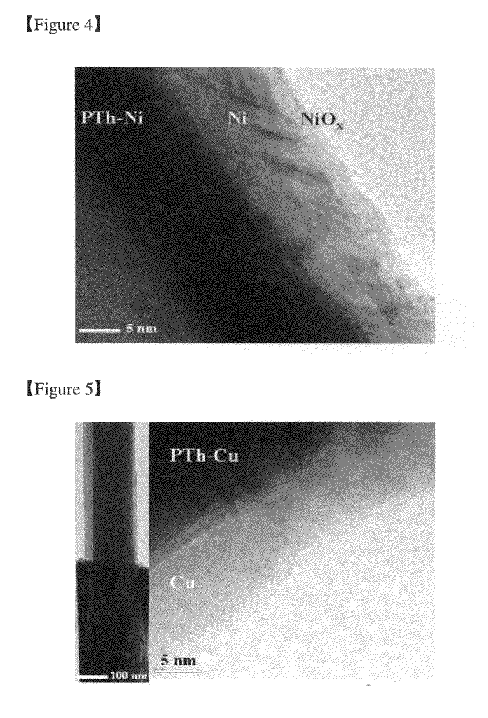

FIG. 3 shows a transmission electron microscopy (TEM) image and a diffraction pattern of one of the double walled PTh/Ni nanotubes, confirming that Ni was formed on the outer surface of the PTh nanotubes and the hybrid nanotube had a diameter of 200 nm. FIG. 4 is a high-resolution transmission electron microscopy (HR-TEM) image of one of the double walled PTh/Ni nanotubes, confirming that Ni was deposited on the PTh nanotubes and a nickel oxide (NiOₓ) layer was formed on the outermost surface. FIG. 5 shows a transmission electron microscopy (TEM) image and a HR-TEM image of one of the double walled PTh/Cu nanotubes. The double walled nanotubes were found to have a length of 10-40 μm and a diameter of about 200 nm. The light-emitting polymer nanomaterials and the metal layers were found to have a thickness of about 10 nm.

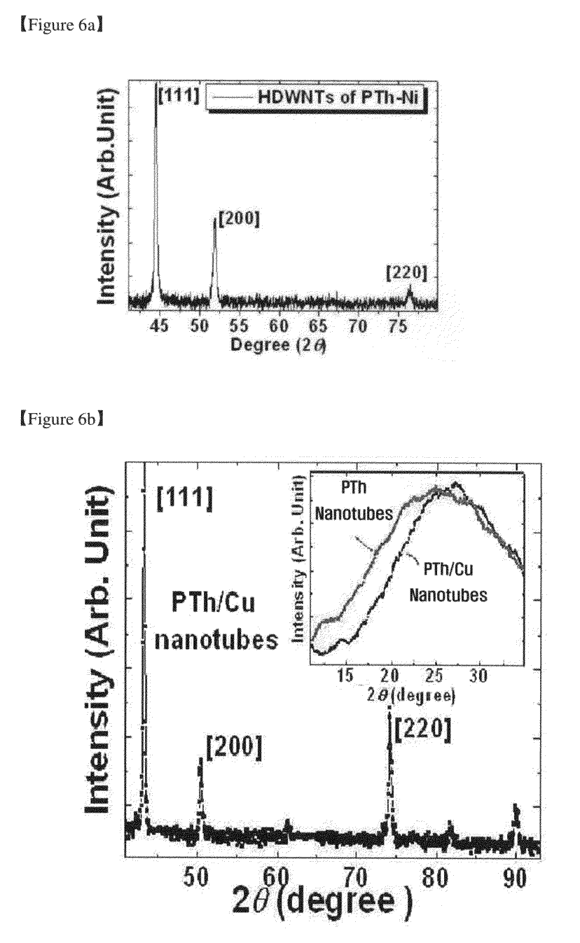

FIGS. 6a and 6b show the results of X-ray diffraction analysis for the PTh/Ni nanotubes and the PTh/Cu nanotubes. The results of the analysis demonstrate the presence of Ni and Cu in the respective nanotubes. Further, the outermost Ni was confirmed to have a face-centered cubic (FCC) structure and a lattice constant of about 0.2 nm, and the outermost copper was confirmed to have a face-centered cubic (FCC) structure and a lattice constant of about 0.21 nm. These results agree well with the lattice spacings and analytical values obtained from the ring patterns in the images measured by HR-TEM. The graph in the upper right corner of FIG. 6b shows the results of X-ray diffraction analysis for the PTh nanotubes and the double walled PTh—Cu nanotubes, demonstrating no significant structural change.

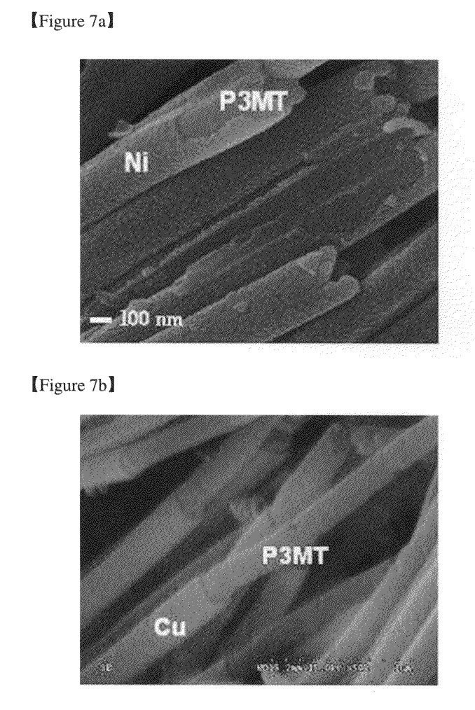

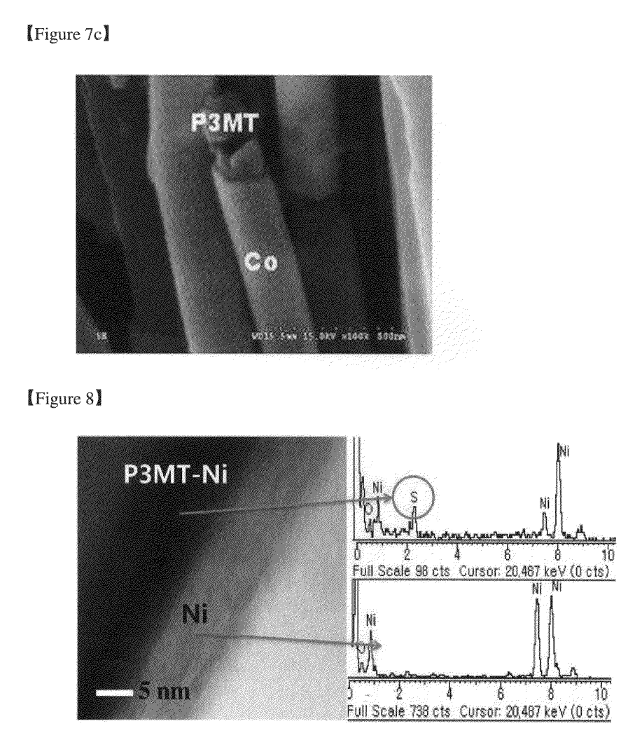

FIGS. 7a, 7b and 7c are SEM images of the double walled nanotubes composed of poly(3-methylthiophene) (P3MT) nanotubes and nickel (7a), copper (7b) and cobalt (7c), respectively. These images show the growth of the metals nickel, copper and cobalt on the outer surfaces of the light-emitting polymer nanomaterials.

FIG. 8 shows a HR-TEM image and the results of energy dispersive spectra (EDS) of one of the P3MT-Ni nanotubes. Referring to FIG. 8, it can be seen that the nanoscale crystalline nickel layer was uniformly coated on the outer surface of the P3MT nanotube. As a result of the EDS analysis, nickel and sulfur (S) of the P3MT were detected within the P3MT-Ni nanotube, revealing that the nanoscale nickel layer was uniformly formed on the outer surface of the light-emitting polymer nanotube.

The metal-polymer hybrid nanomaterial was found to have a diameter of about 200 nm, and the light-emitting polymer and the nickel layer was found to have a thickness of about 10 nm.

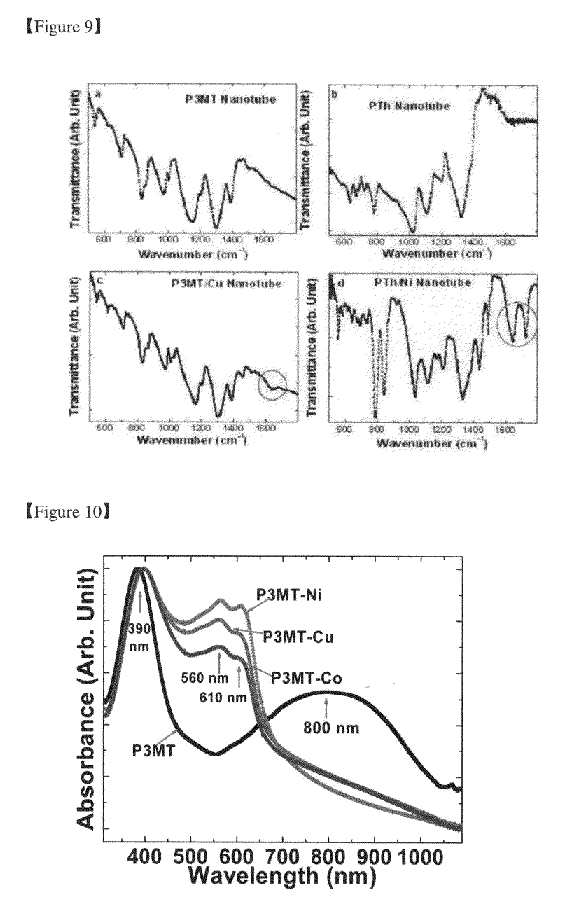

FIG. 9 shows Fourier transform infrared (FT-IR) spectra of PTh nanotubes, P3MT nanotubes, the PTh/Ni nanotubes and the P3MT/Cu nanotubes. Referring to FIG. 9, it can be confirmed that the PTh and P3MT nanotubes were well formed and there were no significant structural changes in the main chains of the double walled nanotubes. The peaks observed in FIG. 9 were analyzed and the results are shown in Tables 2 and 3.

TABLE 2

| FT-IR Assignments | PTh | PTh/Ni |
|---|---|---|
| Cβ-H out of plane bending | 634, 784 | 642, 842 |
| Cα-H out of plane bending | 723 | 787 |
| Cβ-H in plane bending | 1026 | 1036 |
| C—C stretching | 1201 | 1208 |
| C═C stretching | 1326 | 1330 |
| Ring stretching | 1388 | 1383 |
| | 1431 | 1435 |
| | 1508 | 1490 |
| | 1618 | 1509 |
| | | 1647 |
| | | 1728 |

TABLE 3

| FT-IR Assignments | P3MT | P3MT/Cu |
|---|---|---|
| Cβ-H out of plane bending | 629, 837 | 617, 833 |
| Cα-H out of plane bending | 735 | 737 |
| Cβ-H in plane bending | 1004 | 1008 |
| C—C stretching | 1203 | 1203 |
| C═C stretching | 1301 | 1307 |
| Methyl C—H in-phase bending | 1390 | 1389 |
| Ring stretching | 1454 | 1455 |
| | 1510 | 1514 |
| | | 1643 |

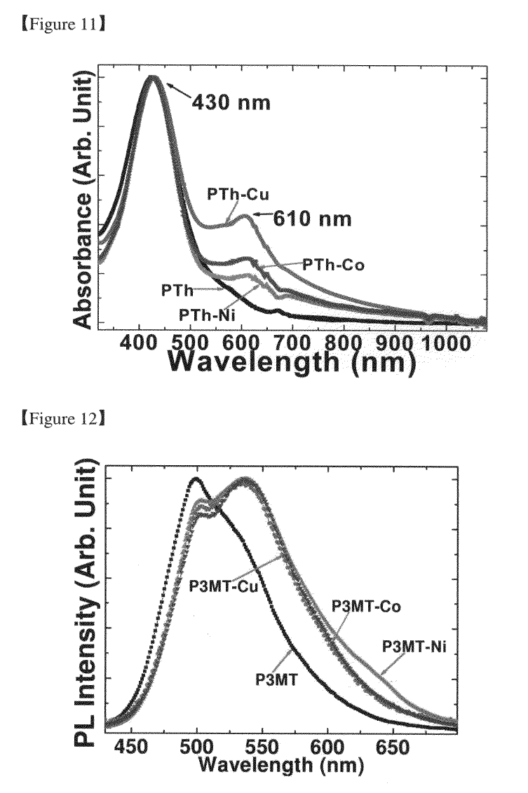

FIGS. 10 and 11 show UV/Vis absorption spectra of the PTh nanotubes, the P3MT nanotubes and the different kinds of P3MT-metal hybrid nanotubes in respective chloroform (CHCl₃) solutions. It can be confirmed from the absorption curves that the double walled nanotubes were structurally different from the PTh and P3MT nanotubes. The π-π* transition peaks of the P3MT and PTh nanotubes were observed at 390 nm and 430 nm in the chloroform solutions, respectively. There were no significant changes in the π-π* transition peaks of the double walled nanotubes, but new absorption peaks appeared at 560 nm and 610 nm, probably due to the presence of surface plasmon (SPs).

FIG. 12 shows photoluminescence (PL) spectra of the different kinds of double walled nanotubes in chloroform (CHCl₃) solutions. As is evident from FIG. 12, the P3MT nanotubes emitted light around 500 nm whereas the P3MT-metal nanotubes showed a red shift and emitted light around 540 nm.

Comparison of Fluorescence Intensities and Spectra

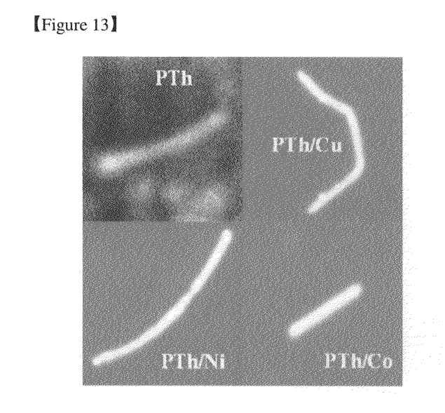

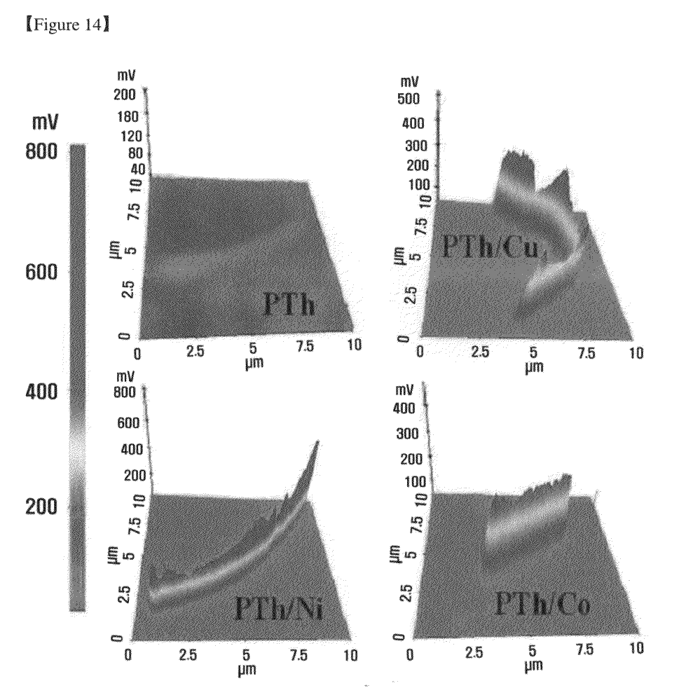

FIG. 13 shows two-dimensional emission images of single strands of the different kinds of double walled PTh-metal nanotubes, which were measured by laser confocal microscopy, and FIG. 14 shows three-dimensional images comparing the amounts of light emitted from single strands of the different kinds of double walled PTh-metal nanotubes, which were measured by laser confocal microscopy. The fluorescence intensities of the PTh and PTh-metal nanotubes are shown in Table 4.

TABLE 4

| | Fluorescence intensity | |
|---|---|---|
| Example 1 | 0.3-0.6 | V |
| Example 2 | 0.7-0.8 | V |
| Example 3 | 0.4-0.45 | V |
| Comparative Example 1 | 8-12 | mV |

As can be seen from the results in Table 4, the light from the hybrid nanotubes of Examples 1, 2 and 3 was about 25-100 times brighter than the light from the PTh nanotubes of Comparative Example 1.

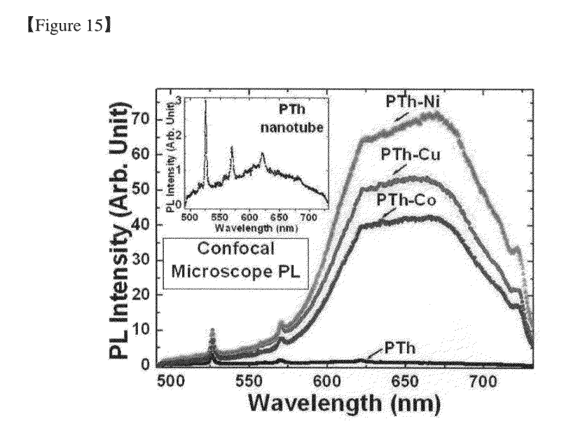

FIG. 15 shows PL spectra of single strands of the different kinds of double walled PTh-metal nanotubes, which were measured by laser confocal microscopy. The PTh nanotubes showed a greater red shift than when measured in the chloroform solution and had a maximum PL intensity around 600 nm. In contrast, the PL intensities of the PTh-metal nanotubes showed a steep increase around 580 nm and PL peaks were observed at 630 and 680 nm. Assuming that the difference in intensity between the maximum peaks of the PTh nanotubes is defined as ‘1’, the intensity difference was 70 for the PTh/Ni nanotubes, 50 for the PTh/Cu nanotubes and 40 for the PTh/Co nanotubes, indicating the greatly increased luminescence intensities of the double walled nanotubes.

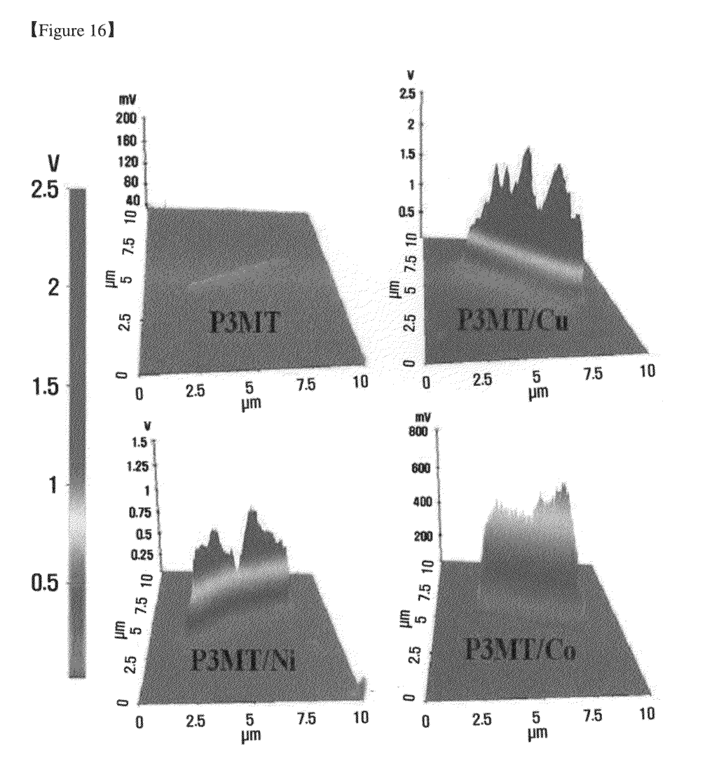

FIG. 16 shows three-dimensional images comparing the amounts of light emitted from single strands of the different kinds of double walled P3MT-metal nanotubes, which were measured by laser confocal microscopy. The fluorescence intensities measured in the P3MT and the P3MT-metal nanotubes are shown in Table 5.

TABLE 5

| | Fluorescence intensity | |
|---|---|---|
| Example 4 | 1.6-2.5 | V |
| Example 5 | 1.0-1.4 | V |
| Example 6 | 0.5-0.8 | V |
| Comparative Example 2 | 15-20 | mV |

As can be seen from the results in Table 5, the light from the hybrid nanotubes of Examples 4, 5 and 6 was about 25-167 times brighter than the light from the P3MT nanotubes of Comparative Example 2.

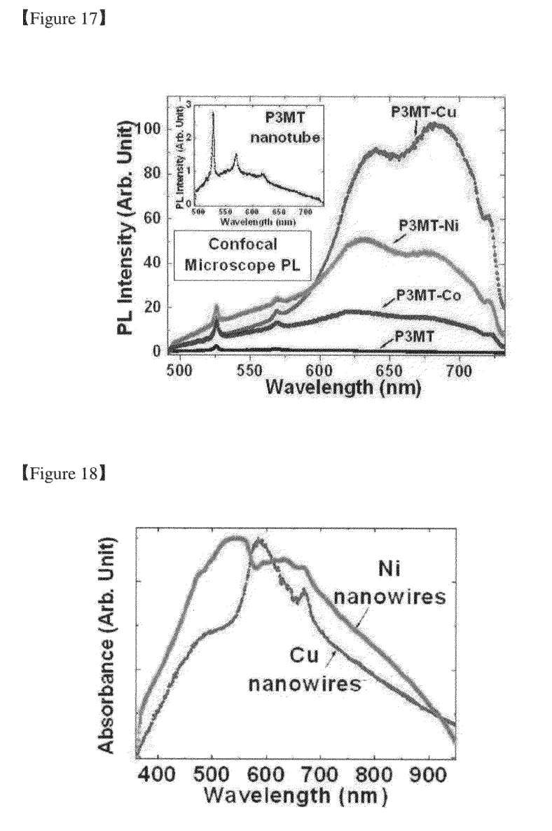

FIG. 17 shows PL spectra of single strands of the different kinds of double walled P3MT-metal nanotubes, which were measured by laser confocal microscopy. The P3MT nanotubes showed a greater red shift than when measured in the chloroform solution and had a maximum PL intensity around 580 nm. In contrast, the PL intensities of the P3MT-metal nanotubes showed a steep increase around 580 nm and PL peaks were observed at 630 and 680 nm. Assuming that the difference in intensity between the maximum peaks of the P3MT nanotubes is defined as ‘1’, the intensity difference was 100 for the P3MT/Cu nanotubes, 50 for the P3MT/Ni nanotubes and 20 for the P3MT/Co nanotubes, indicating the greatly increased luminescence intensities of the double walled nanotubes.

From these results, the present inventors discovered the following phenomena. Although the light-emitting polymer nanomaterials had a relatively low PL intensity in a solid state, the double walled nanotubes composed of the light-emitting polymer nanomaterials and the nanoscale metal layers surrounding the light-emitting polymer nanomaterials showed greatly increased PL intensity. Further, when the P3MT nanotubes were grown and Ni was partially grown with time, the PL intensity was steeply varied at the interfaces between the P3MT and Ni. These results demonstrate that the structure of the metal layers contributed to an improvement in the luminescent properties of the light-emitting polymer nanomaterials.

FIG. 18 shows UV/Vis absorption spectra of nickel and copper nanowires measured to analyze the luminescent properties of the double walled nanotubes. Specifically, nickel and copper nanowires grown without the use of the light-emitting polymer nanomaterials were measured for UV/Vis absorption to identify the features of the double walled nanotubes. FIG. 18 reveals that the features of the double walled nanotubes resulted from the nanoscale metal layers. The double walled nanotubes were measured for PL efficiency to analyze their luminescent properties, and the results are shown in Table 6.

TABLE 6

| | Q.Y (Φ_{QY}) |
|---|---|
| Comparative Example 1 | 0.053 ± 0.011 |
| Example 1 | 0.102 ± 0.011 |
| Example 2 | 0.108 ± 0.023 |
| Example 3 | 0.112 ± 0.010 |
| Comparative Example 2 | 0.045 ± 0.006 |
| Example 4 | 0.101 ± 0.013 |
| Example 5 | 0.116 ± 0.016 |
| Example 6 | 0.119 ± 0.016 |

The results in Table 6 demonstrate that the nanotubes of Examples 1-6 showed about 2-2.5 fold higher PL efficiency than the nanotubes of Comparative Examples 1-2. As a result of analyzing the results, the most important reason why the double walled nanotubes showed excellent luminescent properties is believed to be because more excitons were created by surface plasmons. Consequently, it can be concluded that the use of the light-emitting polymer nanomaterials and the metal whose surface plasmon band gap matches the band gap of the light-emitting polymer nanomaterials greatly increased the luminescence efficiency of the nanotubes.

### Experimental Example 2

Identification of Doping State Through UV/Vis Absorption Curves

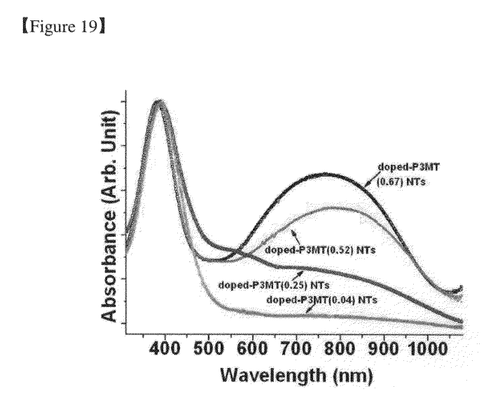

First, light-emitting polymer (P3MT) nanotubes were synthesized by an electrochemical method. After the doping state of the nanotubes was controlled using a cyclic voltammeter, porous alumina templates were removed by dipping in HF. The light-emitting polymer nanotubes were homogeneously dispersed in chloroform and measured for UV/Vis absorption. FIG. 19 shows UV/Vis absorption spectra of the light-emitting polymer (P3MT) nanotubes at different doping levels in chloroform solutions. Referring to the spectra, a maximum peak corresponding to the absorption transition was observed at 390 nm and the absorption intensity of the nanotubes at 800 nm corresponding to the bipolaron absorption was increased with increasing doping level. Assuming that the intensity of the absorption transition was ‘1’, the intensities corresponding to the bipolaron absorption were adjusted to 0.67, 0.52, 0.25 and 0.04.

### Experimental Example 3

Comparison of Luminescence Intensity By Confocal Microscopy

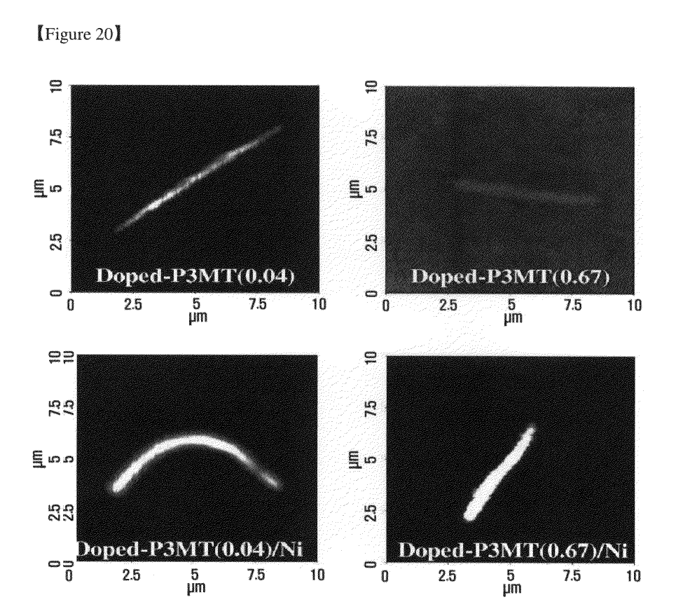

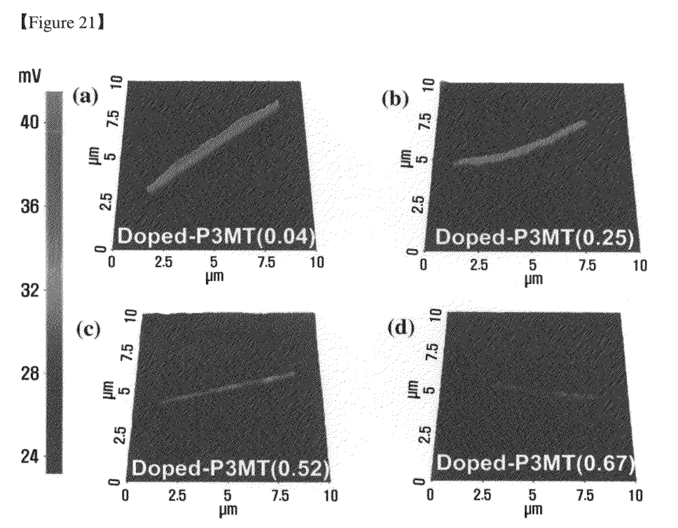

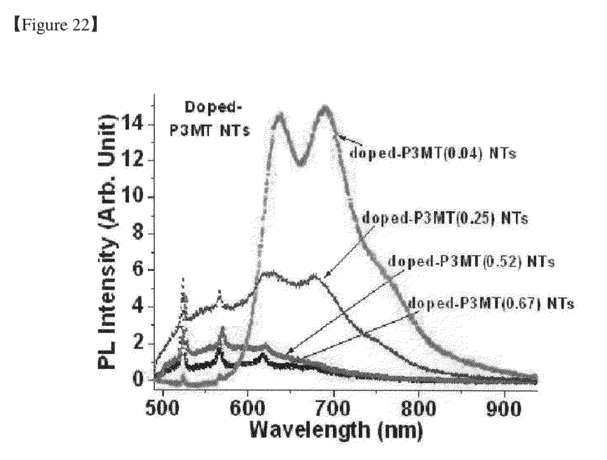

FIG. 20 shows two-dimensional photoluminescence images comparing the photoluminescence intensities of the P3MT nanotubes and double walled P3MT/Ni hybrid nanotubes at different doping levels (0.04 and 0.67), which were measured by confocal microscopy. The P3MT/Ni hybrid nanotubes were composed of the P3MT nanotubes and nanoscale nickel layers surrounding the P3MT nanotubes. The luminescence intensity of the P3MT nanotubes was lowest at a doping level of 0.67 and increased with decreasing doping level (0.04). In contrast, the luminescence intensity of the P3MT/Ni nanotubes enormously increased with increasing doping level from 0.04 to 0.67. For a more quantitative comparison, the luminescence intensities of single stands of the P3MT nanotubes were measured in volt (V) to express three-dimensional emission images, and the PL intensities of single stands of the P3MT nanotubes were measured (FIG. 22). Referring to FIGS. 21 and 22, the luminescence intensities increased with decreasing doping level and the maximum emission peak was red shifted. Specifically, the intensities measured in the emission image of the nanotubes at doping levels of 0.04 and 0.67 were about 40-44 mV and about 5-8 mV, respectively, which were about 5-11 times lower than those measured at the lower doping level (0.04). When the PL intensity at the highest doping level (bipolaron absorption intensity=0.67) was normalized as ‘1’, the PL intensity at the lowest doping level (bipolaron absorption intensity=0.04) was 14. Further, as the doping level decreased, the photoluminescence intensities were sharply increased at about 560-580 nm in the green light range and the maximum peaks were red shifted to 640 and 685 nm to emit red light.

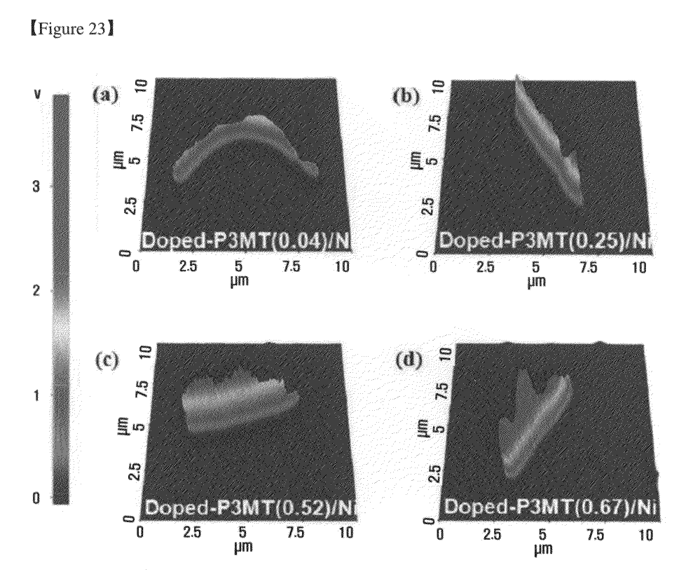

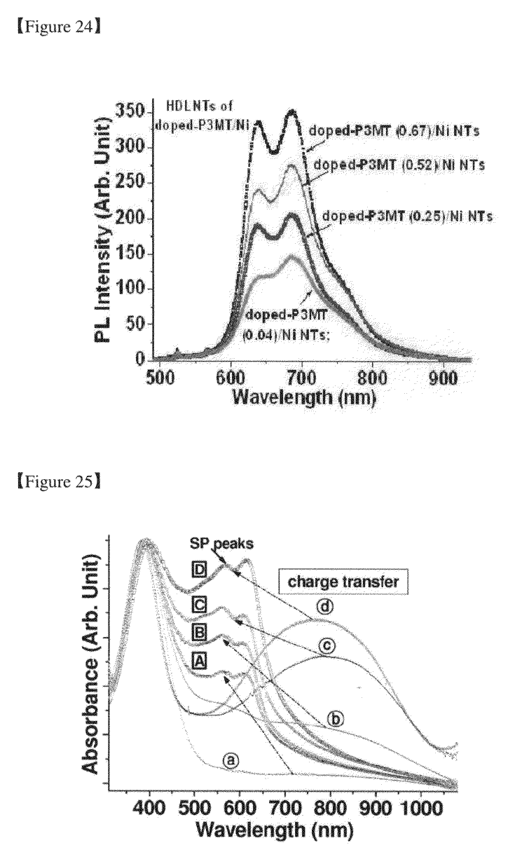

In FIGS. 23 and 24, the luminescence intensities of the P3MT/Ni hybrid nanotubes were compared at different doping levels by laser confocal microscopy. Referring to the figures, the photoluminescence intensities were sharply increased around 580 nm and photoluminescence peaks were observed at 630 and 680 nm, irrespective of the bipolaron intensities. It was observed that the photoluminescence intensities of the nanotubes surrounded by the nanoscale nickel layers in the presence of few bipolaron states (doping level=0.04) and at the strongest bipolaron intensity (doping level=0.67) were about ten times and about 350 times higher than the photoluminescence intensity of the simple P3MT nanotubes. Referring to the three-dimensional emission images of FIG. 23, the luminescence intensities of the nanotubes at doping levels of 0.04 and 0.67 were about 1.2-1.6 V and about 3.1-3.8 V. The reason why an increase in luminescence intensity with increasing doping level is because the number of excitons was increased by energy transfer and electron transfer, as previously explained.

Tables 7 and 8 show data obtained by comparing the luminescence intensities of the P3MT nanotubes and the P3MT/Ni hybrid nanotubes with the three-dimensional PL image intensities and the PL intensities at different doping levels.

TABLE 7

| | Three-dimensional | | Three-dimensional |
|---|---|---|---|
| | PL image | | PL image |
| Nanotubes | intensity | Nanotubes | intensity |
| Doped-P3MT (0.67) | 5-8 mV | Doped-P3MT (0.67)/Ni | 3.1-3.8 V |
| Doped-P3MT (0.52) | 12-16 mV | Doped-P3MT (0.52)/Ni | 2.5-2.7 V |
| Doped-P3MT (0.25) | 26-31 mV | Doped-P3MT (0.25)/Ni | 1.8-2.1 V |
| Doped-P3MT (0.04) | 40-44 mV | Doped-P3MT (0.04)/Ni | 1.2-1.6 V |

TABLE 8

| | PL | | Increment in |
|---|---|---|---|
| Nanotubes | intensity | Nanotubes | PL intensity |
| Doped-P3MT (0.67) | 1 | Doped-P3MT (0.67)/Ni | 350 |
| Doped-P3MT (0.52) | 2 | Doped-P3MT (0.52)/Ni | 135 |
| Doped-P3MT (0.25) | 6 | Doped-P3MT (0.25)/Ni | 35 |
| Doped-P3MT (0.04) | 14 | Doped-P3MT (0.04)/Ni | 10 |

### Experimental Example 4

Enormous Increase in Luminescence Efficiency—Analytical Results

To analyze changes in the luminescence efficiency of the light-emitting polymer nanotubes and enormous increases in the luminescence efficiency of the double walled P3MT hybrid nanotubes, UV/Vis absorption spectra and photoluminescence quantum efficiency of the nanotubes were measured. FIG. 25 shows UV/Vis absorption spectra recorded to prove the occurrence of charge transfer in the bipolaron state. The small letters a, b, c and d represent P3MT (0.04), P3MT (0.25), P3MT (0.52) and P3MT (0.67), respectively, and the capital letters A, B, C and D represent P3MT(0.04)/Ni, P3MT(0.25)/Ni, P3MT(0.52)/Ni and P3MT(0.67)/Ni, respectively.

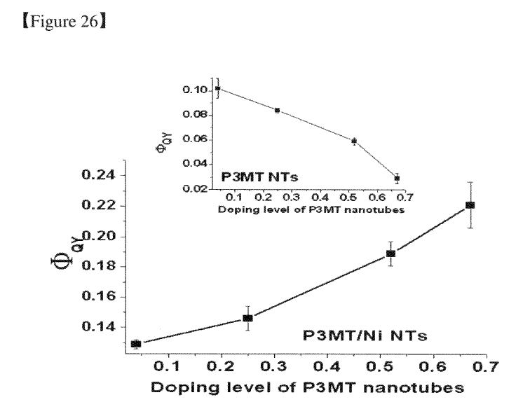

Referring to the UV/Vis absorption spectra, π-π* transition peaks of the P3MT nanotubes were observed at 390 nm in respective chloroform solutions. Although there were no significant changes in the π-π* transition peaks of the P3MT/Ni nanotubes, new absorption peaks were observed at 563 and 615 nm, probably due to the generation of surface plasmons (SPs), and their intensities were increased as the doping level increased from 0.04 to 0.67, i.e. the bipolaron state became stronger. This is because charge transfer and energy transfer through the bipolaron state occurred in the hybrid P3MT nanotubes surrounded by the nanoscale nickel layers. FIG. 26 shows the PL quantum efficiency of the P3MT nanotubes and the P3MT/Ni hybrid nanotubes measured for the analysis of the luminescence efficiency depending on the bipolaron state. As the bipolaron state increased from 0.04 to 0.67, the PL quantum efficiency of the P3MT nanotubes in chloroform solutions showed a tendency to decrease from 0.102 to 0.029, whereas that of the P3MT/Ni hybrid nanotubes showed a tendency to increase from 0.129 to 0.221. The highest photoluminescence quantum efficiency of the P3MT/Ni hybrid nanotubes was observed when the bipolaron state was strongest. Specifically, the photoluminescence quantum efficiency of the P3MT/Ni hybrid nanotubes was increased from 0.102 to 0.129 (1.3 times) at a doping level of 0.04 and from 0.029 to 0.221 (7.6 times) at a doping level of 0.67.

### Experimental Example 5

Energy Band Diagram for Analysis of Enormous Increase in Luminescence Efficiency

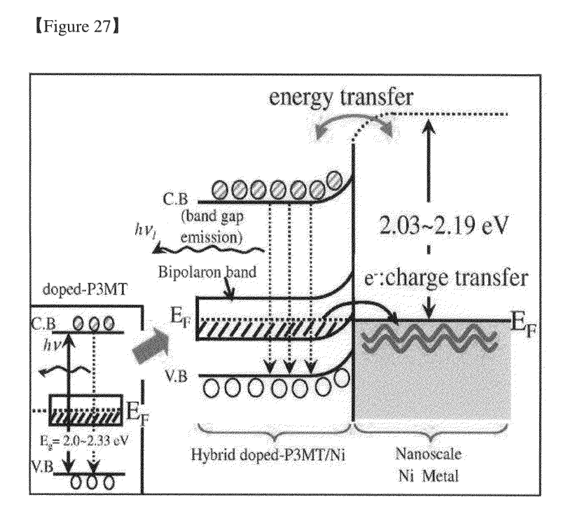

FIG. 27 is a conceptual energy band diagram for the analysis of an enormous increase in the luminescence efficiency of the P3MT/Ni nanotubes. From the above results, the most important reason why the polymer-metal hybrid nanomaterials showed excellent luminescent properties is likely to be due to an increase in the number of excitons by energy transfer and charge transfer based on surface plasmon resonance. The enormous increase in luminescence efficiency by surface plasmon resonance in FIG. 27 can be explained as follows. The P3MT in a dedoping state has a band gap energy of about 2.0 eV. The surface plasmon energy of the nanoscale nickel is about 2.03 to 2.19 eV (563 and 615 nm), and the band gap of the light-emitting polymer P3MT is controllable to 2.0-2.3 eV depending on the doping level. When the nickel and the P3MT form a nanoscale junction, the Fermi energy level of the metal is adjusted to that of the P3MT by the metal-semiconductor junction and the surface plasmon energy of the nickel lies above the conduction band of the P3MT. That is, depending on the doping state of the P3MT, electrons are transferred to the nickel through bipolarons formed within the band gap of the P3MT and energy is transferred to the P3MT through the surface plasmon resonance energy level of the nickel. As a result, more excitons are created to induce an enormous increase in the luminescence efficiency of the light-emitting polymer P3MT.

### INDUSTRIAL APPLICABILITY

As is apparent from the foregoing, energy transfer and electron transfer based on surface plasmon resonance increases the number of excitons in the conduction band of the nanotubes or nanowires including the light-emitting polymer, resulting in a remarkable increase in the luminescence intensity of the metal-polymer hybrid nanomaterials according to the present invention. The metal-polymer hybrid nanomaterials of the present invention are easy to prepare and inexpensive while possessing inherent electrical and optical properties of carbon nanotubes. In addition, the electrical and optical properties of the metal-polymer hybrid nanomaterials according to the present invention can be easily controlled. Based on these advantages, the metal-polymer hybrid nanomaterials of the present invention can be applied to a variety of optoelectronic devices, including light-emitting diodes, solar cells and photosensors.

1. Metal-polymer hybrid nanomaterials comprising nanotubes or nanowires and metal layers formed on the inner or outer surfaces of the nanotubes or the outer surfaces of the nanowires wherein the nanotubes or nanowires include a light-emitting π-conjugated polymer and the metal layers are composed of a metal whose surface plasmon energy level is close to the energy band gap of the nanotubes or nanowires.

2. The hybrid nanomaterials according to claim 1, wherein energy is transferred by surface plasmon resonance between the surface plasmon energy level of the metal layers and the conduction band of the nanotubes or the nanowires.

3. The hybrid nanomaterials according to claim 1, wherein the light-emitting π-conjugated polymer is doped with a dopant to form a bipolaron band within the band gap of the nanotubes or nanowires and electrons present in the bipolaron band are transferred to the Fermi level of the metal layers by surface plasmon resonance.

4. The hybrid nanomaterials according to claim 1, wherein the light-emitting π-conjugated polymer is selected from the group consisting of polythiophene, poly(3-alkylthiophene), poly(3,4-ethylenedioxythiophene), polypyrrole, polyaniline, poly(1,4-phenylenevinylene), polyphenylene, derivatives thereof, and mixtures thereof.

5. The hybrid nanomaterials according to claim 1, wherein the metal layers are composed of at least one material selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), and composites thereof.

6. The hybrid nanomaterials according to claim 4, wherein the dopant is selected from the group consisting of camphorsulfonic acid, benzenesulfonic acid, p-dodecylbenzenesulfonic acid, tetrabutylammonium hexafluorophosphate, tetrabutylammonium tetrafluoroborate, 1-butyl-3-methylimidazolium hexafluorophosphate, naphthalenesulfonic acid, poly(4-styrenesulfonate), HCl, p-toluenesulfonic acid, and mixtures thereof.

7. The hybrid nanomaterials according to claim 1, wherein the metal layers have a thickness of 1 to 50 nm.

8. A method for preparing metal-polymer hybrid nanomaterials, the method comprising
(a) attaching an electrode metal to nanoporous templates,
(b) mixing a polar solvent, a monomer and a dopant with stirring to prepare a solution, and polymerizing the solution within the nanopores of the nanoporous templates to form nanotubes or nanowires including a light-emitting π-conjugated polymer,
(c) electrochemically depositing a metal whose surface plasmon band gap is close to the band gap of the nanotubes or nanowires on the inner or outer surfaces of the nanotubes or the outer surfaces of the nanowires to form metal layers, and
(d) removing the porous templates.

9. The method according to claim 8, wherein the polar solvent is selected from the group consisting of H₂O, acetonitrile, N-methylpyrrolidinone, and mixtures thereof.

10. The method according to claim 8, wherein the monomer is selected from the group consisting of thiophene, 3-methylthiophene, 3-alkylthiophene, 3,4-ethylenedioxythiophene, pyrrole, aniline, 1,4-phenylenevinylene, phenylene, derivatives thereof, and mixtures thereof.

11. The method according to claim 8, wherein the dopant is selected from the group consisting of camphorsulfonic acid, benzenesulfonic acid, p-dodecylbenzenesulfonic acid, tetrabutylammonium hexafluorophosphate, tetrabutylammonium tetrafluoroborate, 1-butyl-3-methylimidazolium hexafluorophosphate, naphthalenesulfonic acid, poly(4-styrenesulfonate), HCl, p-toluenesulfonic acid, and mixtures thereof.

12. The method according to claim 8, wherein the metal is selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), composites thereof, and mixtures thereof.

13. The method according to claim 8, wherein the metal is deposited by applying a voltage of 0 to −1.0 V to the inner or outer surfaces of the nanotubes or nanowires using a cyclic voltammeter.

14. The method according to claim 8, wherein the porous templates are removed by dipping in an aqueous HF or NaOH solution.

15. A method for controlling the optical properties of metal-polymer hybrid nanomaterials, the method comprising
(a) attaching an electrode metal to nanoporous templates,
(b) mixing at least one polar solvent selected from the group consisting of H₂O, acetonitrile and N-methylpyrrolidinone, at least one monomer selected from the group consisting of thiophene, 3-methylthiophene, 3-alkylthiophene, 3,4-ethylenedioxythiophene, pyrrole, aniline, 1,4-phenylenevinylene, phenylene and derivatives thereof, and a dopant with stirring to prepare a solution, and polymerizing the solution within the nanopores of the nanoporous templates to form nanotubes or nanowires including a light-emitting π-conjugated polymer,
(c) dipping the nanotubes or nanowires in an organic solution, and doping and dedoping the nanotubes or nanowires using a cyclic voltammeter,
(d) electrochemically depositing a metal whose surface plasmon band gap is close to the band gap of the nanotubes or nanowires on the inner or outer surfaces of the nanotubes or the outer surfaces of the nanowires to form metal layers, and
(e) removing the porous templates.

16. The method according to claim 15, wherein the organic solution is a solution of a dopant in acetonitrile.

17. The method according to claim 15, wherein the dopant may be selected from the group consisting of camphorsulfonic acid, benzenesulfonic acid, p-dodecylbenzenesulfonic acid, tetrabutylammonium hexafluorophosphate, tetrabutylammonium tetrafluoroborate, 1-butyl-3-methylimidazolium hexafluorophosphate, naphthalenesulfonic acid, poly(4-styrenesulfonate), HCl, p-toluenesulfonic acid, and mixtures thereof.

18. The method according to claim 15, wherein the metal is selected from the group consisting of copper (Cu), nickel (Ni), cobalt (Co), iron (Fe), zinc (Zn), titanium (Ti), chromium (Cr), silver (Ag), gold (Au), platinum (Pt), aluminum (Al), composites thereof, and mixtures thereof.

19. The method according to claim 15, wherein the metal is deposited by applying a voltage of 0 to −1.0 V to the inner or outer surfaces of the nanotubes or nanowires using a cyclic voltammeter.

20. The method according to claim 15, wherein the porous templates are removed by dipping in an aqueous HF or NaOH solution.

21. The method according to claim 15, wherein the luminescence intensity of the metal-polymer hybrid nanomaterials increases with increasing doping level.

22. The method according to claim 15, wherein the optical properties of the metal-polymer hybrid nanomaterials are controlled by an electron transfer mechanism in which a bipolaron band is formed within the band gap of the nanotubes or nanowires by the dopant and electrons present in the bipolaron band migrate to the Fermi level of the metal layers by surface plasmon resonance.

23. An optoelectronic nanodevice comprising the metal-polymer hybrid nanomaterials according to claim 1.
